(19) United States
(12) Patent Application Publication
(10) Pub. No.: US 2006/0208640 A1
(43) Pub. Date: Sep. 21, 2006

(54) Electrode system provided with a novel connection, associated lamp comprising said film and method for the production of said connection

(75) Inventor: Bodo Mittler, Stadtbergen (DE)

Correspondence Address: OSRAM SYLVANIA INC, 100 ENDICOTT STREET, DANVERS, MA, 01923, US

(73) Assignee: Patent-Treuhand-Gesellschaft Fur Elektrish Glulampen MBH, Munchen (DE)

(21) Appl. No.: 10/566,715

(22) PCT Filed: Jul. 19, 2004
(86) PCT No.: PCT/DE04/01561

§ 371 Date: Feb. 1, 2006

(30) Foreign Application Priority Data
Aug. 6, 2003 (DE) 10336087.5

(51) Int. Cl. H01J 61/36; H01J 5/50

(52) U.S. Cl. 313/623; 313/574; 313/331

(57) ABSTRACT

An electrode system with a new type of join, as well as an associated lamp including this foil and a process for producing the join are described. In an electrode system for the lamp industry, a Mo foil (4) is joined to a pin-like joining partner (2) by the foil (4) and/or the pin-like joining partner (2) being coated (5, 8) with ruthenium. The pin is flattened (3) at the end. A contactless welding process produces a spot fusion welded join (6) which is surrounded by an annular high-temperature soldered join (7). This type of join is insensitive to embrittlement.

### TECHNICAL FIELD

The invention relates to an electrode system with a new type of join, to an associated lamp comprising this foil, and to a process for producing the join, in accordance with the preamble of claim 1. It deals in particular with molybdenum foils which are used for pinches as are customary for sealing incandescent lamps and discharge lamps.

### PRIOR ART

U.S. Pat. No. 5,021,711 has already disclosed an electrode system. To improve the resistance to oxidation, the foil is provided with a protective layer of Al, Cr, Si, Ti or Ta. The thickness is from 5 to 100 nm.

DE-A 199 61 551 has disclosed the use of Ru-containing foils in the lamp industry. In this case, a uniform coating of at least one side of the foil is recommended. That document recommends a brazing process as the joining technique, as a departure from the previous welded join.

### SUMMARY OF THE INVENTION

It is an object of the present invention to provide an electrode system in accordance with the preamble of claim 1 which is able to withstand mechanical loads and is corrosion-resistant, with these properties being retained even under high thermal loads.

This object is achieved by the characterizing features of claim 1. A further object is to provide a lamp with a long life and, moreover, to provide a process for producing a highly durable join between parts of an electrode system. These objects are achieved by the characterizing features of claims 10 and 11.

Particularly advantageous configurations are to be found in the dependent claims.

The term electrode system in the present context is to be understood as meaning a system which comprises at least one supply conductor and a foil which are joined to one another. In particular, this term is to be understood as meaning a system which comprises a foil and two supply conductors, in particular wires or pins, with the two supply conductors each joined to different ends of the foil. The foils are generally molybdenum foils which may in particular be doped with yttrium oxide, as is known per se (for example DE 198 37 904), while the current feeds may often be wires or electrode pins. These generally consist of molybdenum and/or tungsten, at least as their main constituents. It is preferable for molybdenum and/or tungsten to form at least 70% by weight. Foil and/or supply conductors may be coated according to the invention, in which case there is a maximum limit of at most 100 nm on the layer thickness for foils, since otherwise a tight glass/metal join is not ensured, whereas in the case of the supply conductors the coating thickness may be from 0.1 to 5 μm. A layer thickness of from 2.5 to 4 μm is preferred in this case.

Hitherto, there has been no solution allowing the ability to withstand corrosive attacks, in particular from aggressive fills as used in the lamp industry, to be increased. Hitherto, therefore, it has been necessary to accept a limited life.

A new joining technique provides a considerable improvement in this respect. The following process is adopted:

To prepare a join between a pin-like part, i.e. a wire, pin or coil of wire with a straight wire termination, and a foil, usually of molybdenum, it is advantageous first of all for the pin-like part, which is always referred to below just as a pin for the sake of simplicity, to be stamped, in particular flattened or planarized in some other way, at its part intended to form the join.

On the other side, the foil or pin is advantageously coated with ruthenium or another material at least in the region of a region intended to form the join. The preferred layer thickness of the ruthenium layer on the foil is from 5 to 100 nm. A layer thickness of between 20 and 75 nm is particularly preferred. The diameter of the pin is preferably in the range from 0.1 to 0.6 mm. The planarization preferably takes place over a third to a sixth of the original diameter. A preferred thickness of the flattened portion which is formed is approximately 50 to 250 μm. As an alternative or in addition, the coating extends to the supply conductor. There, the coating thickness is selected to be between 0.1 and 5 μm. A layer thickness of from 2.5 to 4 μm is preferred there.

The foil may in this case be coated on one side (even only partially) or on two sides. The coating on the side facing the pin is important.

The foil and the pin are then brought into contact with one another in such a way that the coated surface on the wide side of the foil is arranged on the planarized surface of the pin.

In the simplest case, i.e. according to the basic principle, the two parts which are to be joined are contactlessly welded to one another by the application of high-energy radiation, for example by an electron beam or laser beam, for example Nd:YAG. The parameters in this case are to be selected in such a way that the introduction of heat is sufficient not only to form a fusion welded join, i.e. spot fusion or in very general terms partial fusion in a central region of the two joined parts. The introduction of heat must also be sufficient for an adjoining region, often referred to below as the halo, to receive sufficient heat for it to partially melt but just produce a soldered join. This can be controlled particularly well by using the coating, in which case only the coating melts and produces a soldered join during cooling. A Ru-containing coating is particularly suitable in this respect. The Ru-coated surface is typically melted in a generally annular zone around the weld spot, in a region in which the temperature is slightly lower. As a result, the melting of the Ru coating in the halo leads to an additional join by means of high-temperature soldering between the joining partners. In the text which follows, this special type of mixed joining technology is referred to as a solder-encircled welded join. The process parameters depend on the particular circumstances. The use of a pulsed energy supply is crucial. Pulses in the millisecond range with a sufficient introduction of heat for dissipation of heat into the adjacent zone outside the welded join still to be ensured are typical. The higher the introduction of heat above a certain threshold, the wider the resulting annular zone becomes. A diameter of the spot welded join of 0.5 mm and a width of the adjoining zone of 0.2 mm are typical. If suitable optics are used, however, the welded region can also be made significantly larger, for example up to three times larger in the case of elongated optics.

Surprisingly, it has emerged that it is by this technique possible to overcome the drawback which has hitherto frequently been observed with a standard welded join, namely the considerable embrittlement, since the weld location produced contactlessly is boosted by the annular halo, in which the join is based purely on high-temperature soldering.

Only contactless joining processes with a high power density, preferably at least 10⁸ W/cm², are suitable for this purpose.

They bring about tightly delimited fusion and advantageously cause little change to the ruthenium-coated surface. As a result, the high corrosion resistance of an untouched ruthenium-coated foil which exists is only impaired to a slight extent.

The preferred planarization of the pin not only leads to good contact, which allows the contactless welding to take place at all, but also leads to a reduced build-up of stresses in the join between the metal of the pin and the quartz glass surrounding it in the case of a pinch seal in a bulb glass with a high SiO₂ content, in particular consisting of Vycor or quartz glass.

The electric lamps according to the invention have a lamp vessel made from quartz glass or hard glass with a high SiO₂ content provided with molybdenum foil leadthroughs which form part of at least one pinch seal of the lamp vessel. At least one molybdenum foil is pinched in a gastight manner within the at least one pinch seal. The foil should preferably contain a doping of the yttrium oxide in an amount of from 0.5 to 1.5%.

### BRIEF DESCRIPTION OF THE DRAWINGS

In the text which follows, the invention is to be explained in more detail on the basis of a number of exemplary embodiments. In the drawing:

FIG. 1 shows an electrode system;

FIG. 2 shows a side view of a discharge lamp;

FIG. 3 shows a side view of an incandescent lamp;

FIG. 4 shows a side view of a further discharge lamp;

FIG. 5-7 show further exemplary embodiments of electrode systems.

### PREFERRED EMBODIMENT OF THE INVENTION

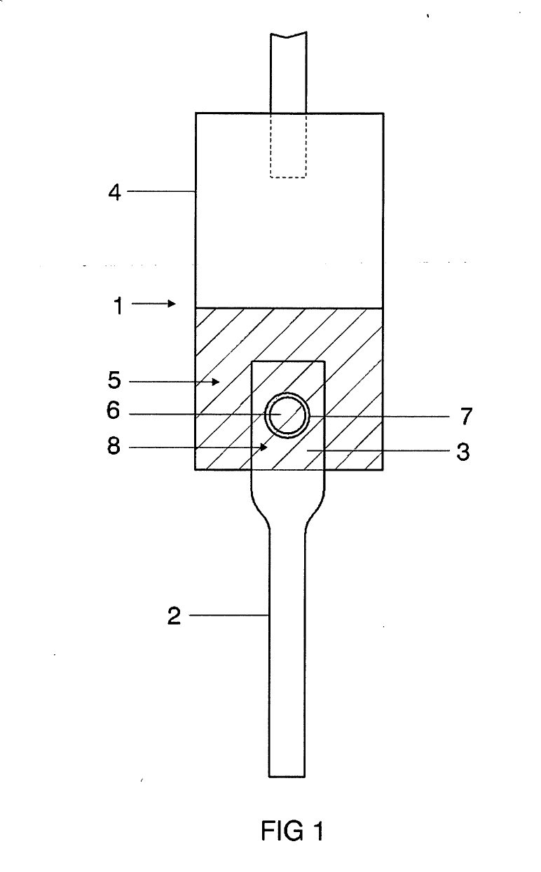

FIG. 1 shows an electrode system 1 having a pin-like part 2, the end piece 3 of which is flattened and which is joined to a molybdenum foil 4. A strip of the molybdenum foil 4 lying in its lower half is covered with a 100 nm thick ruthenium layer 5. The part 2 is a supply conductor made from molybdenum with a diameter of 370 μm which at the end 3 is flattened in a spade shape to 100 μm and is likewise covered with a ruthenium layer 8, in this case 2.5 μm thick, in the spade-shaped region. The join between these two joining partners is ensured by a spot weld 6 with a diameter of approximately 400 μm. This is surrounded by a ring 7 of high-temperature soldered material, the ruthenium here acting as solder with a lower melting point than the two joining partners. The external diameter of the ring is approximately 550 μm.

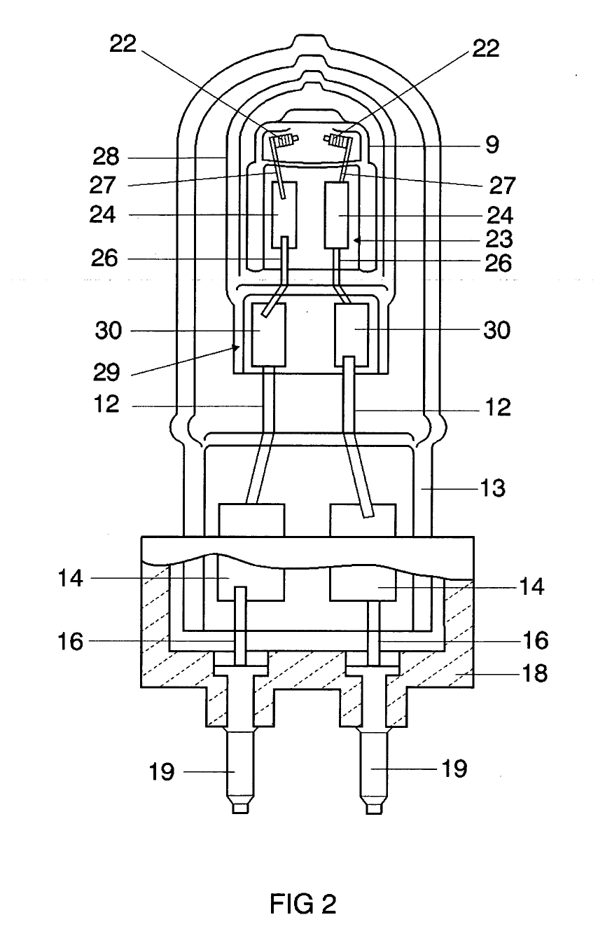

The exemplary embodiment of an application for a lamp illustrated in FIG. 2 is a high-pressure discharge lamp which is capped on one side. This lamp has a discharge vessel 9 made from quartz glass which is pinched on one side and encloses an ionizable fill, which comprises corrosive metal halides, in a gastight manner. Two electrodes 22 with shank 27 are arranged within the discharge vessel 9 and are each electrically conductively connected, by means of the shank 27 and via a molybdenum foil 24 embedded in the pinch seal 23 of the discharge vessel 9, to in each case one current feed 26 projecting out of the discharge vessel 9.

The discharge vessel 9 is surrounded by a covering bulb 28 which is closed off in a gastight manner and is pinched on one side. The covering bulb 28 consists of quartz glass doped with approx. 0.5 percent by weight of cerium. Nitrogen gas, which at room temperature has a cold-filling pressure of between 600 mbar and 700 mbar, is located within the covering bulb 28. The current feeds 26 which project out of the discharge vessel are in each case electrically conductively connected, via a molybdenum foil 30 embedded in the pinched foot 29 of the covering bulb 28, to a current feed 12 which leads out of the covering bulb 28. An outer bulb 13 which is pinched on one side and capped on one side surrounds the covering bulb 28 in a gastight manner. The outer bulb 13 is evacuated and likewise consists of a quartz glass doped with approx. 0.5 percent by weight of cerium. The current feeds 12 which lead out of the covering bulb 28 are in each case electrically conductively connected, via a molybdenum foil 14 embedded in the pinched seal of the outer bulb 13 to a current feed 16 projecting out of the outer bulb 13. The current feeds 16 which lead out of the outer bulb 13 are in electrical contact with the contact pins 19 projecting out of the cap 18. The molybdenum foils used in this exemplary embodiment are all coated with a eutectic Mo—Ru alloy with a thickness of 75 nm on both sides. The composition of this alloy is: molybdenum 43% by weight, ruthenium 57% by weight (preferably at least 40% by weight, advantageously more than 50% by weight of ruthenium). The current feeds 26, 12 and 16 and in each case the electrode shank 27 are flattened at their ends facing the foils 14, 24 and 30 and are in each case joined to the foil alternately “crosswise” by producing a solder-encircled welded join. Coating, flattened portion and welded join are not illustrated, since the scale of the figure is too small to do so. The life of a lamp of this type is thereby increased by at least 20%.

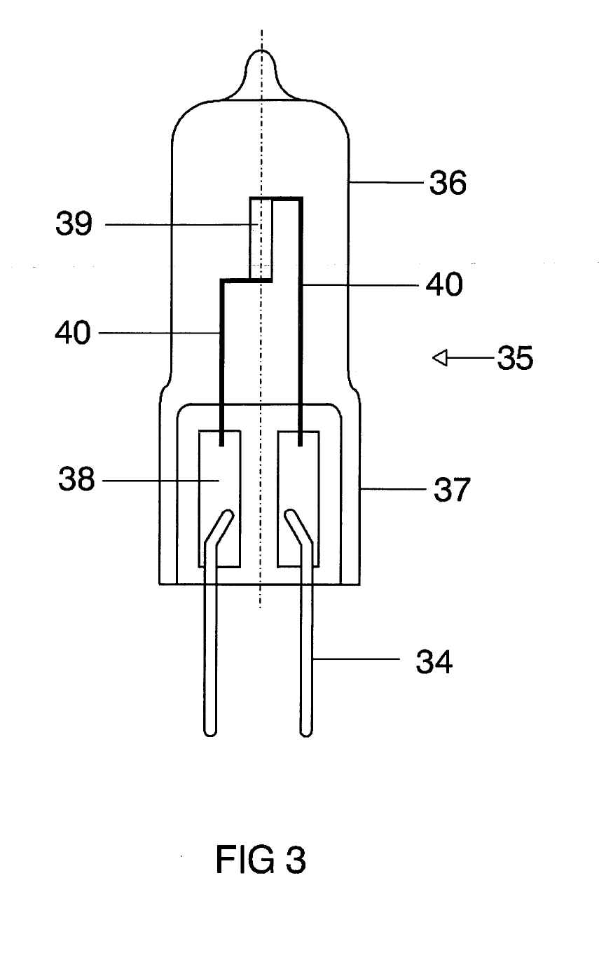

The exemplary embodiment shown in FIG. 3 is a halogen incandescent lamp 35 (12 V at 100 W power) with a lamp bulb 36 made from quartz glass which is closed off in a gastight manner with the aid of a pinch seal 37. Two molybdenum foils 38 are embedded in the pinch seal of the lamp bulb. Inside the lamp bulb is a double-coiled luminous body 39, the single-coiled ends of which act as inner current feed 40. The inner current feeds are each welded to a molybdenum foil 38 embedded in the pinch seal. Two outer current feeds 34, which are each connected to one of the two molybdenum foils, project out of the pinch seal 37. The two molybdenum foils embedded in the pinch seal are coated with a 90 nm thick eutectic Mo—Ru alloy on one side, namely the side to which the current feed 40 is secured. The ends of the outer current feeds are flattened and joined to the foils by the solder-encircled welded joins (not shown).

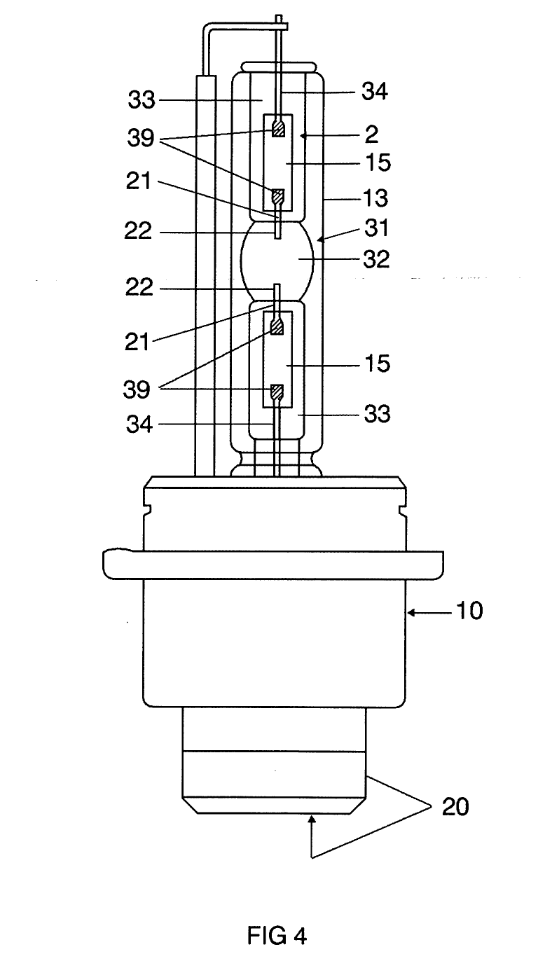

A further application area is low-wattage discharge lamps for motor vehicle headlamps. The lamp shown in FIG. 4 is a metal halide lamp, with or without mercury, with an electrical power consumption of 35 W. It has a discharge vessel 31 made from quartz glass with a discharge volume 32 and two diametrically arranged pinches 33 which each have an outer current feed 34. These current feeds are connected to two electrodes 22 in the discharge volume 32. The fill also contains high-pressure xenon. The discharge vessel is surrounded by an outer bulb 13. Furthermore, a plastic cap 10 holds the two vessels 31, 13. It is equipped with electrical terminals 20. The connection between the shanks 21 of the electrodes and the foil 15 and also between the Mo pins 34 and the foil 15 is made by means of a solder-encircled welded join. The spade-shaped end regions of the shanks 21 and of the Mo pins 34 are coated (39) with Ru with a layer thickness of 3 μm.

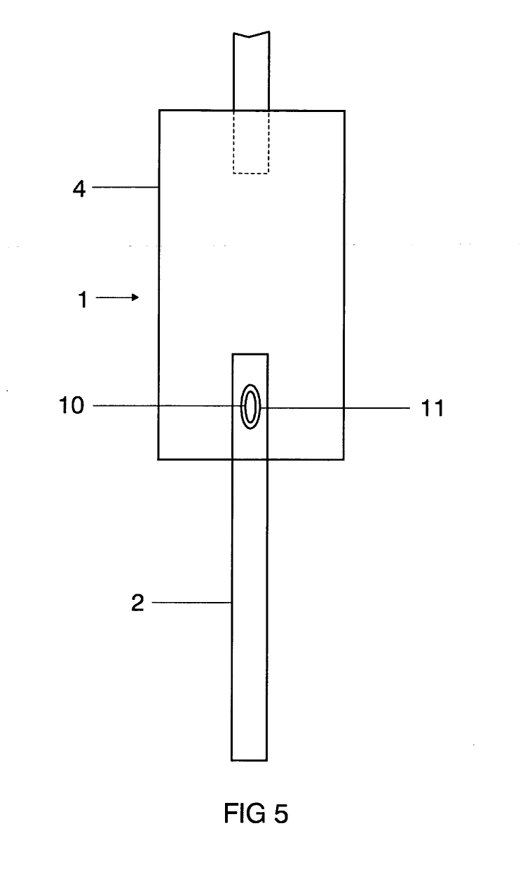

If a high load is applied to the join between the two parts that are to be joined, namely foil (4) and pin-like supply conductor (2), it is possible to use a differently configured welded region (10), for example a significantly elongated welded region, cf. FIG. 5, instead of a more or less circular central weld spot (6) as shown in FIG. 1. The considerable range of possible shapes includes in particular oval, elliptical and rectangular welded regions with rounded corners. This elongation can be realized, for example, with cylinder lenses connected upstream of the laser beam used for the welding. Accordingly, a halo (11) which is similarly elongate also extends around the welded region.

In this example, there is no coating. The current feed 2 is a wire made from tungsten which is not flattened at the end.

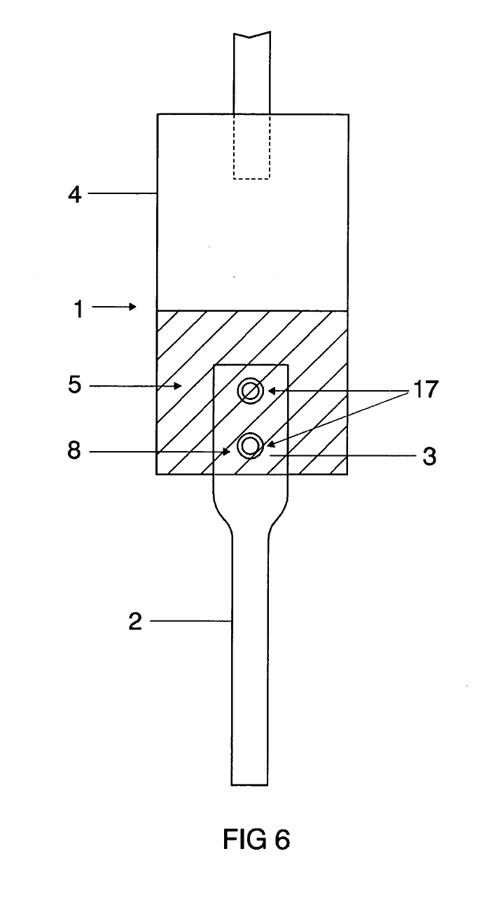

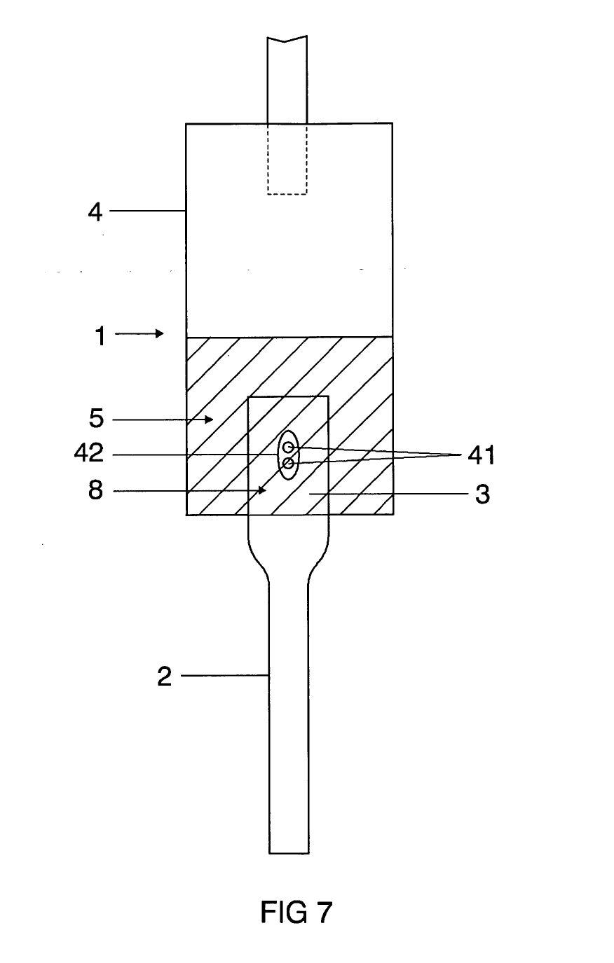

In particular, it is, of course, possible to use more than one welded spot between the parts that are to be joined, cf. FIGS. 6 and 7. In this case, by way of example, two weld spots each with a halo (17) are placed above one another. The two weld spots (41) may, however, also be positioned so close together that they are surrounded by a single halo (42). This can be realized using bifocal optics. A plurality of weld spots improve the dissipation of heat.

It is preferable for the second part to lie on that side of the first part which faces the laser beam. In this case, the laser melts the second part, making the join particularly intimate.

If the two parts to be welded are suitably dimensioned, it is possible to do without a coating.

A flattened portion may be appropriate and desirable depending on the material of the second part, in particular when using a large diameter and ductile material, such as molybdenum. Given suitable dimensions, in particular a relatively small diameter of the second part, with material with a low ductility, such as tungsten, however, it is also possible to do without a flattened portion.

1. An electrode system, in particular for the lamp industry, comprising at least one foil (4) as a first part of the electrode system having a metallic base body of molybdenum, pure or doped, and a pin-like supply conductor (2) made from metal as second part of the electrode system, predominantly or completely comprising molybdenum or tungsten, the two parts (2, 4) being joined to one another, characterized in that a join is realized between the pin-like supply conductor (2) at its end facing the foil (4) and the foil (4) by combined welding and soldering as a result of at least one central welded region (6) being surrounded by a halo (7) of a high-temperature soldered join.

2. The electrode system as claimed in claim 1, characterized in that the coating consists of pure ruthenium or a ruthenium compound or alloy, in particular a eutectic molybdenum-ruthenium alloy, with a layer thickness of between 0.02 and 5 μm.

3. The electrode system as claimed in claim 2, characterized in that the coating is applied to the foil, in a layer thickness of between 0.02 and 0.1 μm.

4. The electrode system as claimed in claim 2, characterized in that the coating is applied to the supply conductor, in a layer thickness of between 0.1 and 5 μm.

5. The electrode system as claimed in claim 1, characterized in that the pin-like supply conductor (2), at its end facing the foil (4), has a flattened portion (3), in the region of which the join to the foil (4) is made.

6. The electrode system as claimed in claim 1, characterized in that the welded region is in the form of a spot, a circle or elongate in form.

7. The electrode system as claimed in claim 1, characterized in that two welded regions are used to produce the join.

8. The electrode system as claimed in claim 1, characterized in that a coating (5, 8), in particular a ruthenium-containing coating, is at least partially applied to at least one of the two parts.

9. The electrode system as claimed in claim 1, characterized in that the flattened portion (3) is from 50 to 200 μm thick.

10. The electrode system as claimed in claim 1, characterized in that the pin-like supply conductor (2) has a diameter of from 0.1 to 0.6 mm.

11. The electrode system as claimed in claim 1, characterized in that a further supply conductor is secured to the foil (4) in a similar way.

12. The electrode system as claimed in claim 1, characterized in that the foil (4) is doped with yttrium oxide, in particular in an amount of from 0.5 to 1.5%.

13. The electrode system as claimed in claim 1, characterized in that the spot welded join (6) has a diameter of at most 150% of the diameter of the pin-like part.

14. The electrode system as claimed in claim 1, characterized in that the diameter of the halo (7) amounts to at most 130% of the diameter of the spot welded join (6).

15. A lamp comprising the electrode system as claimed in claim 1.

16. A lamp comprising a lamp vessel (36) made from quartz glass or hard glass with a high SiO₂ content, which at least at one end is provided with a pinch seal (37) and with inner and outer current feeds (40, 34) and contains a luminous means (39) and if appropriate a fill, the lamp being provided with at least one electrode system as claimed in claim 1, characterized in that the supply conductor is realized by the outer current feed (34), inner current feed (40) or if appropriate an electrode shank.

17. A process for producing a join between parts of an electrode system which includes at least one foil (4) as first part and a pin-like supply conductor (2) as second part, characterized by the following steps:
providing the two parts as joining partners;
producing mechanical contact between the two joining partners;
contactless welding of the two joining partners by means of high-energy radiation, so that the introduction of heat is sufficient to form a central spot welded join which is surrounded by a halo of a high-temperature soldered join.

18. The process as claimed in claim 17, characterized in that the second part is arranged on that side of the first part which faces the radiation.

19. The process as claimed in claim 17, characterized in that the pin-like supply conductor is flattened at its end which is to be joined prior to mechanical contact being made.

20. The process as claimed in claim 17, characterized in that at least one of the two parts is coated with a material which promotes the soldering, in particular ruthenium-containing material, before mechanical contact is made.
